(19) United States
(12) Patent Application Publication
(10) Pub. No.: US 2015/0112787 A1
(43) Pub. Date: Apr. 23, 2015

(54) Amateur Athletics Performance-Based Loyalty Rewards Program and Related Systems, Methods, and Apparatus

(71) Applicants: Kevin Fricke, Austin, TX (US); Matthew Stephens, Austin, TX (US)

(72) Inventors: Kevin Fricke, Austin, TX (US); Matthew Stephens, Austin, TX (US)

(21) Appl. No.: 14/056,284

(22) Filed: Oct. 17, 2013

(51) Int. Cl. G06Q 30/02; G06Q 50/00

(52) U.S. Cl. CPC G06Q 30/0279; G06Q 30/0226; G06Q 50/01
USPC 705/14.27

(57) ABSTRACT

Loyalty rewards systems and methods. Some methods comprise activities such as gathering performance statistics regarding amateur athletes. These methods comprise gathering sponsorship deals associated with the amateur athletes. These methods comprise assigning loyalty reward points to consumers based on the performance statistics and verifying that the sponsor honored the sponsorship. Methods can comprise facilitating a creation of a fantasy amateur athletic team wherein the assigning of the points is further based on a performance statistic associated with the team. Some methods comprise assigning further sponsorship loyalty reward points based on changes in the performance statistics. Methods can comprise providing a template to amateur athletic leagues through which the amateur athletic leagues are granted access to participate in the methods. If desired, sponsors and/or the amateur athletes can be granted access to participate in the method through the template and/or invitations to amateur athletic performances can be sent to social networks.

### BACKGROUND

Many individuals enjoy participating in sports. Most of these people do not have the time, skill, connections, etc. to participate in professional sports such as those associated with Major league Baseball, the National Football League, the National Basketball Association, the National Hockey League, etc. Instead, and often, they participate in their sports of choice via amateur athletic leagues, associations, teams, etc. These leagues in turn provide a framework in which the individuals can participate either as individuals or as a member of one of the teams of the league.

Many of these leagues, teams, etc. attract sponsors who sometimes defray a portion (or all) of the costs of running the league and/or teams. By doing so, at least some of these sponsors hope to foster a sense of loyalty to the sponsor who is often a business of some sort. Those businesses also obtain the opportunity to advertise their wares to audiences (for instance, the participants themselves, league officials, observers, consumers etc.) in an enjoyable setting.

Of course, in many instances the individuals involved in these sports will keep statistics of their performance. And, at some level, the leagues (and/or teams) keep statistics of their performance as well. Yet, these teams, leagues, etc. are not necessarily the best-organized groups and the statistics might or might not be kept with any degree of accuracy. Furthermore, most leagues operate as non-profit organizations meaning that few if any resources are available to the leaders (team captains, coaches, league officials, etc.) to organize the activities and people involved.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. Nevertheless, the current disclosure provides systems, apparatus, methods, etc. for awarding loyalty rewards based on the performance of amateur athletes. More specifically the current disclosure provides systems for awarding loyalty reward points based on the performance of amateur athletes and for redeeming those points at sponsors associated with the amateur athletes, their teams, etc.

Methods in accordance with some embodiments comprise activities such as gathering athletic performance statistics regarding an athletic performance of a plurality of amateur athletes. These methods also comprise accepting sponsorship deals from various sponsor associated with the amateur athletes. In addition, these methods comprise assigning loyalty reward points associated with the sponsorship deal to consumers based on the performance statistics and verifying that the sponsor honored the loyalty reward points on purchases associated with the consumers. Furthermore, systems for performing such methods are provided by embodiments while computer readable media storing processor executable instructions for performing such methods via computers are also provided by embodiments.

Methods of some embodiments further comprise facilitating a creation of a fantasy amateur athletic team from the plurality of amateur athletes wherein the assigning of the loyalty reward points is further based on a performance statistic associated with the fantasy team. Additionally, or in the alternative, some methods further comprise assigning further sponsorship loyalty reward points to the consumers based on changes in the performance statistics associated with the amateur athletes. In another variant, these methods can further comprise providing a template to amateur athletic leagues through which the amateur athletic leagues are granted access to participate in the methods. If desired, sponsors and/or the amateur athletes can be granted access to participate in the method through the template. Embodiments also provide for sending invitations to amateur athletic events through social networks.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures indicates similar or identical items.

FIG. 1 illustrates a block diagram of a system for assigning loyalty reward points based on performance statistics of amateur athletes.

FIG. 2 illustrates a block diagram of an amateur athletics-based loyalty rewards system.

FIG. 3 illustrates a flowchart of a method for assigning loyalty reward points based on performance statistics of amateur athletes.

FIG. 4 illustrates a rewards program data table of embodiments.

### DETAILED DESCRIPTION

This document discloses systems, apparatus, methods, etc. for awarding loyalty rewards which are based on the performance of amateur athletes. More specifically the current disclosure provides systems for awarding loyalty reward points based on the performance of amateur athletes and for redeeming those points at sponsors associated with the amateur athletes, their teams, leagues, etc.

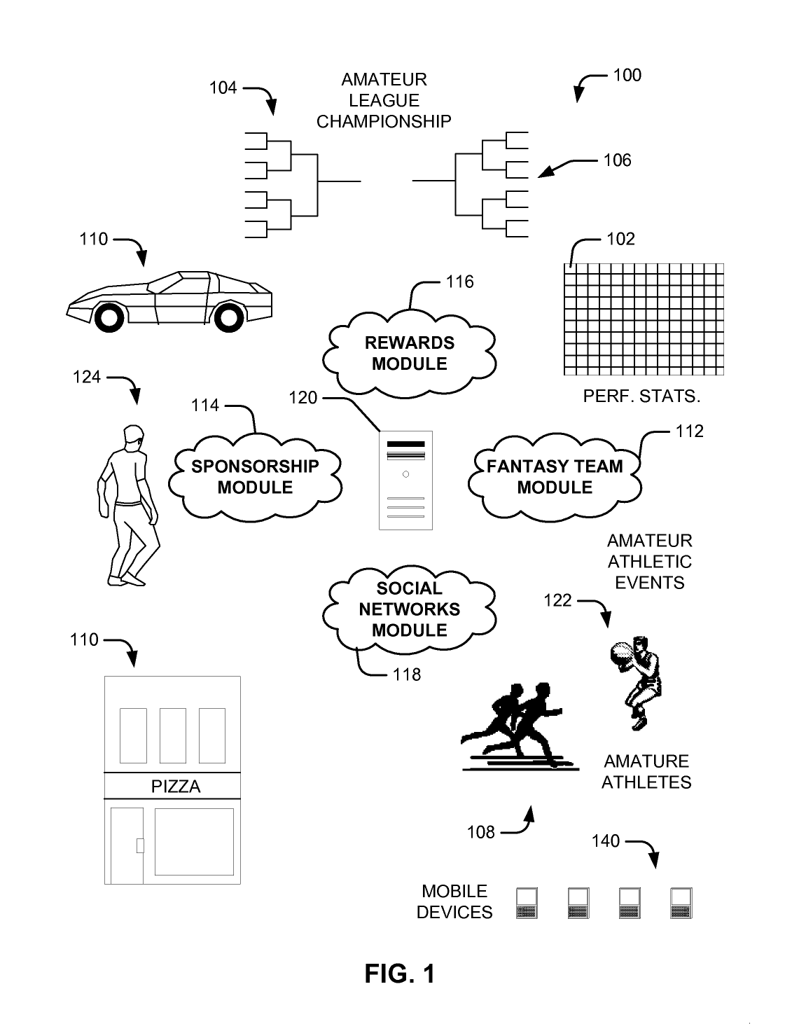

FIG. 1 illustrates a block diagram of a system for assigning loyalty reward points based on performance statistics of amateur athletes. More specifically, FIG. 1 illustrates a system 100, performance statistics 102, a league 104, teams 105, amateur athletes 106, amateur athletic events 108, sponsors 110, a fantasy sports module 112, a sponsorship module 114, a rewards module 116, a social networks module 118, a server 120 or computer, various sporting events 122, and a consumer 124. The system 100 of the current embodiment runs a loyalty rewards program based on the performance of the amateur athletes 106. It gathers performance statistics 102 from the leagues 104, assigns reward points to consumers based on those performance statistics 102, and monitors/verifies activities at participating sponsors 110.

As those skilled in the art will appreciate, the various amateur athletes 108 often form teams 106 to play various sporting games with each other. Although, it is not necessary for the practice of embodiments that the various athletic performances of the amateur athletes be team-based. Rather, individual sporting events fall within the scope of the current disclosure. As the various amateur athletes 108 play, work out, etc. they generate performance statistics 102. These performance statistics 102 span a great variety of activities. For instance, in baseball the number of runs batted in (RBIs), home runs, batting averages, errors, etc. can be tracked and used as the performance statistics 102. In soccer, records can be kept of scores, assists, yellow cards, red cards, etc. Thus, both positive and negative performance statistics 102 can be used as a basis for rewards. Moreover, performance statistics 102 for individual athletic performance can be measured and recorded in the system 100. For instance, the times and distances run by various amateur joggers, sprinters, runners, etc. can be recorded.

The players themselves are amateurs in the current embodiment. These amateur athletes 108 usually participate in sporting events 122 for fun and do not typically receive pay or compensation for their efforts. Moreover, while they can play on teams 106 and/or in leagues, they might also play on their own, in small groups, or even larger groups as when an Internet-based “meet-up” group or a pickup game occurs. These amateur athletes 108 can keep track of and report their performance statistics via their mobile devices 140, computers, etc.

As noted elsewhere herein, the amateur athletes 108 can play on teams 106 and in leagues 104. Each team 106 typically has a captain and/or other leaders who schedule and organize the team 106 and/or the games. These leaders often also keep records of the performance statistics 102 for their teams 106 and/or member players. These team-based performance statistics 102 can be reported to the system 100. Likewise, the amateur athletic leagues 104 also have leaders and/or officials who organize the teams 106 and/or the leagues 104. For instance, these league leaders can maintain records of the performance statistics 102 of the leagues 104, the teams 106, and/or the individual amateur athletes 108.

In addition to the amateur athletes 108, teams 106, and/or leagues 104, the system 100 includes provisions for various sponsors 110. These sponsors 110 often include local businesses which wish to sponsor the amateur athletes 108, teams 106, and/or leagues 104. In return for the money which they donate to the leagues 104, teams 106, etc. they often obtain the right to advertise at the games organized by the leagues 104. For instance, the sponsors 110 some times obtain the right to place a billboard at a game, place their names (or other advertising) on the team jerseys, shorts, uniforms, etc.

In addition, or in the alternative, the sponsors 110 can participate in a loyalty rewards program(s) in accordance with the current embodiment. In the program, the sponsors 110 agree to give various consumers 124 discounts and/or special deals based on reward points assigned to them based on the performance statistics 102 of the various amateur athletes 108 (and/or teams 106, leagues 104, etc.) Because the discounts might entice the consumers 124 into shopping with the sponsors 110 more often than they would otherwise (whether on-line, by phone, in person, etc.), the sponsors 110 stand likely to gain business directly from the program. They also stand likely to gain additional loyalty of these consumers 124 because of the discounts as well as their willingness to help and associate with the amateur athletes 108, teams 106, leagues 104, etc.

Thus, when a consumer 124 desires to join the program, they can select one or more amateur athletes 108 on whom they wish to base their reward points. They can then track the performance statistics 102 of their selected amateur athletes 108 as well as the reward points which they accumulate based on those players' performance statistics 102. When they obtain enough reward points, the consumers can shop at the sponsors 110 who will (in keeping with their assumed obligations) honor the reward points by giving the consumers 124 discounts and/or special deals. The sponsors 110 of course can be any organization willing to participate. But, in many cases, the sponsors 110 will be restaurants, stores, car dealerships, insurance companies, homebuilders, realtors, etc.

The server 120 of course can be in communication with the amateur athletes 108, the team 106, the leagues 104, the sponsors 110, and/or the consumers 124. These communications can occur over the Internet, other WANs/LANs (wide area networks/local area networks), various telecommunication networks, etc. For instance cellular telephony systems can facilitate communications amongst these parties, their mobile devices, other computing devices, point of sale (POS) terminals, etc. Moreover, the server 120 can host, run, execute, etc. an application, program, etc. which embodies the rewards program in accordance with embodiments.

That program can include several different modules (or other programs, sections of code, etc.) For instance, the rewards application can include the fantasy sports module 112, the sponsorship module 114, the rewards module 116, and the social networks module 118. The fantasy sports module 112 of the current embodiment allows users (consumers 124, amateur athletes 108, etc.) to build fantasy sports teams based on the amateur athletes 108. Thus, the users can select the amateur athletes 108 whom they want on their fantasy teams and monitor their performance via the system 100. Note that, in some embodiments, reward points can be assigned based on the performance of these fantasy teams.

Still with reference to FIG. 1, the sponsorship module 114 allows sponsors 110 to join the rewards program and to monitor/maintain their accounts. Thus, the sponsors 110 can access the sponsorship module 114 and verify their enrollment status, determine how many rewards points they have honored, the discounts they have granted, how many consumers 124 have used reward points at their stores, how much they have sold in conjunction with the program, etc. The sponsors 110 can also select amateur athletes 108, teams 106, and leagues 104 to sponsor and/or alter their sponsorship packages via the sponsorship module 114.

The rewards module 116 maintains the rewards points for the various consumers 124 and allows them an entry point into the system 100. Thus, the rewards module 116 allows consumers 124 to log into their accounts (and create them if desired) as well as select the amateur athletes 108 (and teams 106, and/or leagues 104) which they wish to base their rewards upon. The rewards module 116 also allows the consumers 124 to verify their accumulated reward points (and historic records thereof) and to shop online at the sponsors 110. Thus, the rewards module 116 monitors the performance statistics 102 and computes the reward points for the various consumers 124. It also, communicates with the sponsors 110 (or their POS terminals) to determine how many reward points are redeemed by the various consumers 124. Responsive to the redemptions, it also re-computes the accumulated awards for the consumers 124 involved in the redemptions.

FIG. 1 also illustrates the social networks module 118. In some embodiments, the social networks module 118 provides an interface to various social networks such as Facebook, MySpace, etc. Through it, the amateur athletes 108 can post their performance statistics to their friends and other contacts in the social networks. The amateur athletes 108 (and for that matter, the teams 106, leagues 104, etc.) as well as other users can post invitations to their social networks for “pick up” and other more or less spontaneous games.

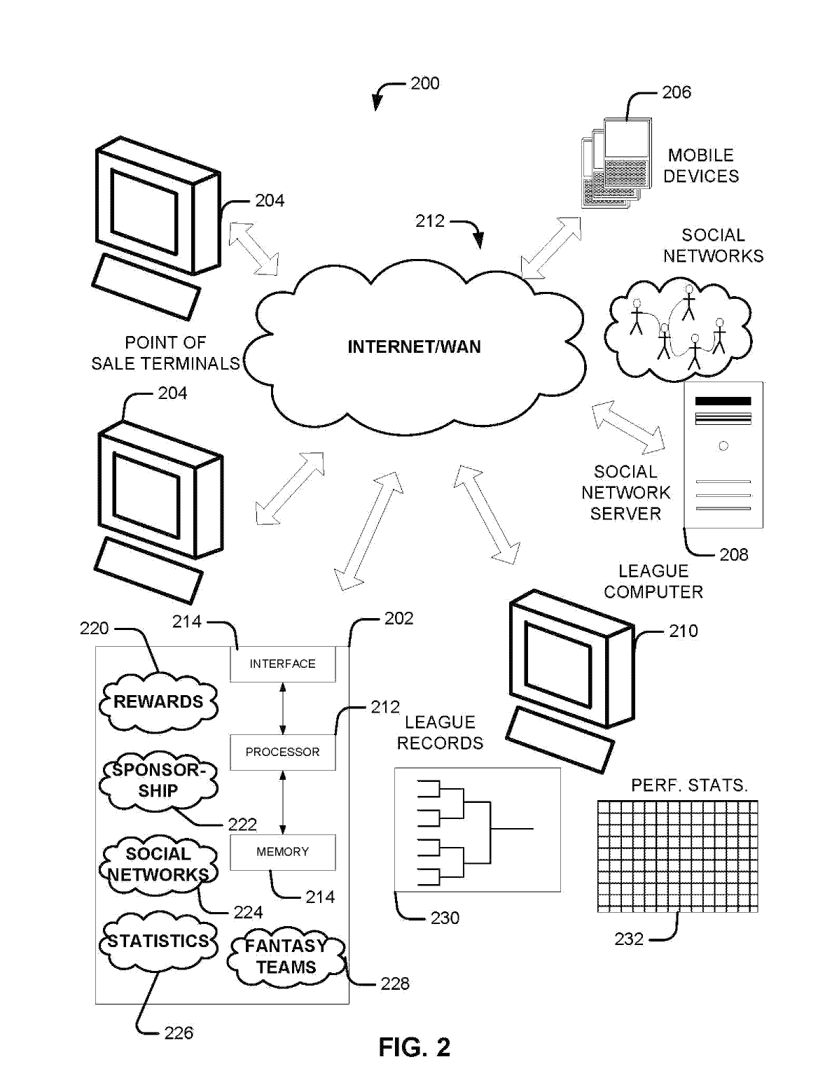

FIG. 2 illustrates a block diagram of an amateur athletics-based loyalty rewards system. More specifically, FIG. 2 illustrates a system 200, a rewards server 202, POS terminals 204, mobile devices 206, a social network server 208, a league computer 210, the Internet 212, a network interface 214, a processor 216, a memory 218, a rewards module 220, a sponsorship module 222, a social networks module 224, a statistics module 226, a fantasy team module 228, a template 229, various league records 230, and performance statistics 232. The rewards server 202 of the current embodiment includes the network interface 214 enabling it to communicate with the POS terminals 204 at (or associated with) the sponsors 110 as well as other devices in the system 200. For instance, many users (amateur athletes 108, consumers 124, etc.) might find it convenient to use mobile devices 206 to log in to their respective accounts in the system 200. Moreover, the league 104 (and teams 106, amateur athletes 108, etc.) involved in the system might have various computers on which they maintain league records 230 and/or performance statistics 232 of potential use to the server 202 and/or the modules 220, 222, 224, 226, and 228 resident on it.

The processor 216 can be any sort of machine or other device capable of executing these modules 220, 222, 224, 226, and/or 228. The memory 218 likewise can be any sort of storage device capable of storing the processor executable instructions which embody many variations of these modules. Additionally, the memory 218 can store the data underlying the rewards program including but not limited to the performance statistics 232, league records 230, etc. Of course, the network interface 214, processor 216, and memory 218 can be in communication with each other as illustrated in FIG. 2. Moreover, they can cooperate to execute these modules and/or provide at least some of the functionality disclosed here in.

The POS terminals 204 can include a wide variety of devices but often include computing devices capable of redeeming reward points during transactions involving the consumers 124. Thus, the POS terminals 204 can incorporate many functions of traditional cash registers as well as those functions involved in exchanging information related to the reward points and/or transactions that might occur at/with the sponsors 110.

Meanwhile, the mobile devices 206 are often smart cellular phones although they need not be. For instance, the mobile devices 206 can be tablets, laptop computers, etc. These mobile devices 206 can host applications, programs, etc. configured with at least the functionality disclosed herein. For instance, the mobile devices 206 can download from the rewards server 202 a graphic user interface with features associated with logging into the system 200 and maintaining accounts thereon. Of course much of the foregoing activity can be conducted over the Internet 212 and/or other telecommunication networks.

The social network server 208 indicates a variety of equipment (and for that matter software) employed by various social networks. These social networks provide a service whereby a member can form on-line relationships with various other members. The members in these relationships are some times termed “friends,” “connections,” etc. Many social networks also allow their members (and perhaps others) to share information about their activities, like, dislikes, their other relationships, and other information pertinent to the member. The social networks module 224 provides an interface to the social networks for users of the system 200. More specifically, it allows a user to post (or otherwise send) their performance statistics 232 to selected social networks and/or their friends, connections, etc. Moreover, the social networks module 224 can allow the user to send invitations to their games (and/or other athletic performances) to their connections in the social networks.

Together, the rewards module 220, the sponsorship module 222, the social networks module 224, the statistics module 226, the fantasy team module 228 and/or any application program interfaces (or the like) on the POS terminals 204, the mobile devices 206, social network servers 208, and/or league computers 210 can serve as the template 229. Thus, the template 229 allows league officials and/or team captains among other users to setup, maintain, run, etc. their own loyalty rewards programs in accordance with embodiments.

Still with reference to FIG. 2, the league computers 210 can be one computer maintained by some league official. But, it could also be a collection of computers maintained by various league officials, team captains, amateur athletes 108 etc. The league computer(s) can therefore store the performance statistics 232, league records 230, etc. They can also provide software, applications, databases, application program interfaces, etc. allowing the rewards server 202 and/or the various modules 220, 222, 224, 226, and/or 228 to communicate with the league computer 210 and/or the performance statistics 232, league records 230, etc. stored thereon.

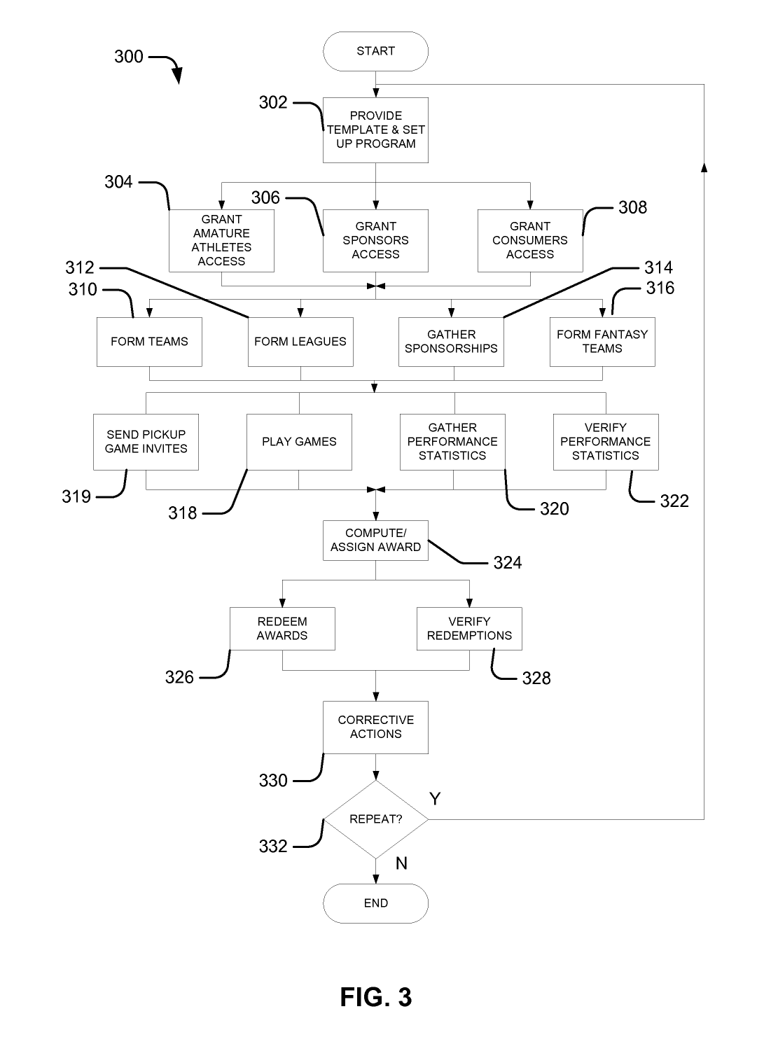

FIG. 3 illustrates a flowchart of a method for assigning loyalty reward points based on performance statistics of amateur athletes. More specifically, in accordance with the current embodiment, method 300 includes providing a template 229 for a loyalty rewards program based on performance statistics 232 of amateur athletes 108. The template 229 can allow league officials, team captains, etc. to set up, maintain, and/or run a loyalty rewards program. And, when desired, these users can set up their rewards programs accordingly. See reference 302.

Method 300 can continue with one or more amateur athletes 108 gaining access to the system 200. The amateur athlete 108 can register with the system 200, post/maintain their performance statistics 232 thereon, and interact with other users of the system 200 (as well as members of various social networks with whom they might have on-line relationships). In some embodiments, the system 200 allows the user to send their performance statistics 232 to various social networks and/or to send invitations to the social networks. See reference 304.

The system 200 can also, or in the alternative, grant access to various sponsors 110. Those sponsors 110 can therefore set up and maintain their accounts. They can also post rewards-related deals and monitor their performance within the rewards programs. See reference 306. Consumers can also access the system 200 and, if desired, shop on-line with the sponsors 110 and/or maintain their accounts on the system 200. For instance, these consumers can select the amateur athletes and/or their particular performance statistics 232 on which they wish to base their reward points. In addition, or in the alternative, these consumers can build fantasy sports teams based on the amateur athletes and link the performance of these fantasy teams to their reward points. See reference 308.

In addition, the template 229 of the current embodiment facilitates certain actions of team and league officials. For instance, the template 229 can allow team captains to communicate with the amateur athletes 108 and/or to form a team from them. Of course, the amateur athletes 108 can be provided similar functionality should they wish to form a team on their own. See reference 310.

Reference 312 indicates that method 300 can also include allowing league officials to build leagues from the various amateur teams registered with the system 200. Thus, the system 200 can allow communications between the various officials of the amateur athletic leagues, the captains of the amateur teams, and/or the amateur athletes 108.

Furthermore, method 300 provides for the league officials, team captains, etc. to gather and/or register sponsorships with the system 200. Thus, these users can communicate with the sponsors 110 via the system 200. Of course, these users can contact the sponsors 110 in person and subsequently register the sponsors 110 and the sponsorship deals with the system 200.

Still with reference to FIG. 3, reference 316 illustrates that various users can use system 200 to form fantasy teams from the amateur athletes 108. For instance, using fantasy team module 228, users can select amateur athletes 108 and add them to and/or delete them from their fantasy team. Of course, thereafter, these users can access system 200 and monitor the performance of their fantasy team as well as the reward points which they garner therefrom.

At some time, the amateur athletes 108 can play various sports games and/or participate in various athletic events. See reference 318. In addition, or in the alternative, various pickup (and other more or less spontaneous) athletic events might be occurring as indicated at reference 319. These spontaneous events can be sparked by invitations sent to the various social networks via the social networks module 224. As the athletic events unfold and/or thereafter, various users (for instance, team captains, league officials, etc.) can gather statistics related to the performance of the amateur athletes 108 involved therein. See reference 320.

Moreover, those performance statistics 232 can be independently verified in accordance with embodiments. For instance, in scenarios in which individuals play on teams, method 300 can rely on the team captain to enter the performance statistics with the players being free to dispute information with which they disagree. Their feedback can be fed back to the captain along with their explanation, comments, etc. The team captain can either confirm or reject the individual's proposed changes. If the team captain and amateur athlete do not agree (which, it is believed, will not happen frequently since they are teammates) then a system administrator can investigate and confirm or reject the proposed changes. Where two (or more) teams who are registered with the system play each other, the performance statistics entered by the two team captains can be cross verified. For instance, a game score could be cross verified and determined to be accurate. To guard against collusion (and resulting falsified statistics), though, method 300 can include multiple points of statistics verification. For instance, any team, team member, team captain, referee, league official, spectator, sponsor, etc. could dispute one or more performance statistics. Thus, method 300 can rely on such forms of “social governance” to police the performance statistics in that anyone can challenge the statistics in accordance with embodiments. See reference 322.

At reference 324, the rewards module 220 can access those performance statistics 232 and compute the rewards points to award to each (or some) of the various consumers. Thus, the rewards module 220 can examine the consumers' accounts and determine upon which amateur athletes 108 and which performance statistics 232 those consumers have based their rewards points. The rewards module 220 can then retrieve the appropriate performance statistics 232 and assign reward points accordingly.

With continued reference to FIG. 3, method 300 can continue with the consumers using their reward points. For instance, consumers can visit a brick and mortar location associated with a sponsor or the consumer can access the sponsor 110 remotely (via the Internet, a cellular telephony system, etc.) and make purchases from the sponsor 110. The consumer and/or the sponsor can designate a particular purchase as being subject to the rewards programs and thus cause rewards points to be redeemed. See reference 326. The system 200 can be configured so that as attempted redemptions are initiated, the rewards module 220 can verify that the consumer has an appropriate number of points for the redemption and that the sponsor 110 has designated a corresponding redemption in their accounts. See reference 328.

Of course, if the rewards module 220 detects a discrepancy it can take corrective/remedial actions. For instance, it can deny the attempted redemption. In the alternative, it could signal the sponsor 110 or administrative user regarding the situation. See reference 330. FIG. 3 also illustrates that the method 300 of the current embodiment can be repeated in whole or in part. See reference 332.

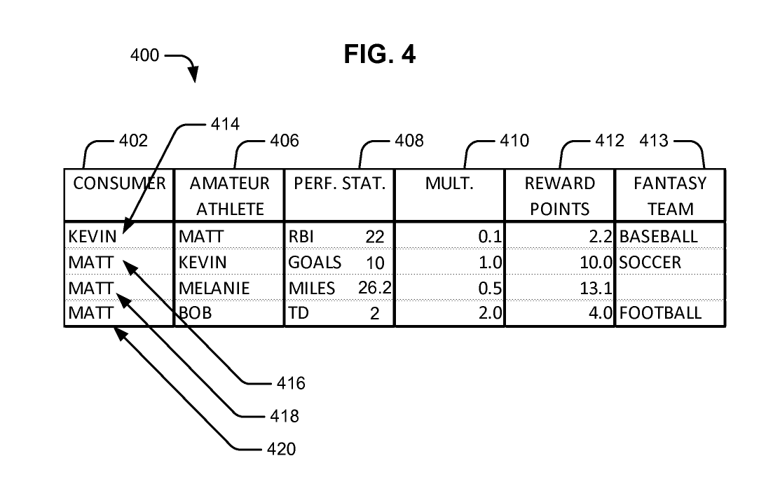

FIG. 4 illustrates a rewards program data table of embodiments. More specifically, FIG. 4 illustrates how the system 200 might distribute reward points based on the performance of various amateur athletes 108. The table 400 includes various columns for the consumers 402, their selected amateur athletes 404, the performance statistics 408 which they selected, a multiplier 410, and their current rewards points 412. Entry 414 illustrates that one consumer Kevin has selected the amateur athlete Matt on which to base his rewards points. Furthermore, Kevin has indicated that Matt's RBIs should result in rewards points being awarded to him. The multiplier of 0.1 (in this illustrative instance) allows the system 200 to account for the wide variety of performance statistics upon which the consumers 124 might want to base their rewards. Accordingly, the multiplier 410 can equalize the points awarded across sports, positions in those sports, etc. Furthermore, FIG. 4 illustrates that Matt has produced 22 RBIs during some period and that those 22 RBIs (after adjustment via the multiplier 410 of 0.1) has caused the system 200 to award 2.2 reward points to Kevin.

Entries 416, 418, and 420 illustrate that Matt has selected several amateur athletes 108 from which he wishes to earn reward points. In the scenario illustrated by FIG. 4, Matt has selected Kevin, Melanie, and Bob as his amateur athletes 108. He has selected, respectively, their goals, miles jogged, and touchdowns upon which to base his reward points. Since Matt has scored 10 goals, Melanie, has jogged 26.2 miles, and Bob has scored 2 touchdowns, Matt's adjusted rewards points are respectively 10.0, 13.1, and 4.0 for a total of 27.1 points.

Additionally, column 413 indicates that the consumers 124 can select which amateur athletes 108 to have on their fantasy team(s). FIG. 4 illustrates that Kevin has selected Matt to be on his fantasy baseball team. Matt, though, has selected Kevin for his fantasy soccer team and Bob for his fantasy football team. Thus FIG. 4 illustrates one way in which the system 200 can award reward points based on the performance of amateur athletes.

Embodiments provide systems for awarding loyalty reward points based on the performance of amateur athletes. Moreover, embodiments provide templates for amateur league officials, team captains, etc. to set up their own rewards programs. In accordance with embodiments, some methods allow sponsors to increase the loyalty with which their customers view them while also, or in the alternative, increasing their sales. Systems of some embodiments also allow amateur athletes to post their performance statistics on social networks while allowing consumers to receive reward points based on those performance statistics.

Thus, systems of embodiments operate despite being in an environment in which the participants (for instance, amateur athletes, league officials, etc.) do not always maintain the performance statistics on which the various rewards programs operate. Moreover, the sponsor-sponsored party relationships have a relatively high likelihood of being local yet far-flung resources (such as the Internet) are used to organize and/or facilitate these local relationships. Further still, in accordance with embodiments, it is amateur athletes upon whose performance the rewards programs are based. This feature of many embodiments further enhances the loyalty that some sponsors will engender, promote, earn, etc. by sponsoring their local (amateur) athletes.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A method comprising:
gathering athletic performance statistics regarding athletic performance of a plurality of amateur athletes;
accepting a sponsorship deal from at least one sponsor associated with the at least one of the amateur athletes;
assigning loyalty reward points associated with the sponsorship deal to a consumer based on a performance statistic associated with one of the amateur athletes; and
verifying that the sponsor honored the loyalty reward points on a purchase associated with the consumer.

2. The method of claim 1 further comprising facilitating a creation of a fantasy amateur athletic team from the plurality of amateur athletes, the assigning of the loyalty reward points being further based on a performance statistic associated with the fantasy amateur athletic team.

3. The method of claim 1 further comprising assigning further sponsorship loyalty reward points to the consumer based on a change in the performance statistic associated with the one of the amateur athletes.

4. The method of claim 1 further comprising providing a template to an amateur athletic league through which the amateur athletic league is granted access to participate in the method.

5. The method of claim 4 wherein a sponsor of the amateur athletic league is granted access to participate in the method through the template.

6. The method of claim 4 wherein an amateur athlete is granted access to participate in the method through the template.

7. The method of claim 1 further comprising sending an invitation to an amateur athletic event to a social network.

8. A system comprising:
an interface;
a processor in communication with the interface; and
a memory in communication with the processor and storing processor executable instructions which when executed by the processor cause the processor to execute a method further comprising
gathering athletic performance statistics regarding athletic performance of a plurality of amateur athletes via the interface;
Accepting a sponsorship deal from at least one sponsor associated with the at least one of the amateur athletes via the interface;
assigning loyalty reward points associated with the sponsorship deal to a consumer based on a performance statistic associated with one of the amateur athletes;
verifying that the sponsor honored the loyalty reward points on a purchase associated with the consumer;
and outputting an indication of the verification via the interface.

9. The system of claim 8 further wherein the method further comprises comprising facilitating a creation of a fantasy amateur athletic team from the plurality of amateur athletes, the assigning of the loyalty reward points being further based on a performance statistic associated with the fantasy amateur athletic team.

10. The system of claim 8 wherein the method further comprises assigning further sponsorship loyalty reward points to the consumer based on a change in the performance statistic associated with the one of the amateur athletes.

11. The system of claim 8 wherein the method further comprises providing a template to an amateur athletic league through which the amateur athletic league is granted access to participate in the method.

12. The system of claim 12 wherein the method further comprises granting a sponsor of the amateur athletic league access to participate in the system through the template.

13. The system of claim 12 wherein the method further comprises granting an amateur athlete access to participate in the system through the template.

14. The system of claim 8 wherein the method further comprises sending an invitation to an amateur athletic event to a social network.

15. A computer readable medium storing processor executable instructions which when executed by a processor cause the processor to perform a method comprising:
gathering athletic performance statistics regarding athletic performance of a plurality of amateur athletes;
accepting a sponsorship deal from at least one sponsor associated with the at least one of the amateur athletes;
assigning loyalty reward points associated with the sponsorship deal to a consumer based on a performance statistic associated with one of the amateur athletes; and
verifying that the sponsor honored the loyalty reward points on a purchase associated with the consumer.

16. The computer readable medium of claim 15 wherein the method further comprises facilitating a creation of a fantasy amateur athletic team from the plurality of amateur athletes, the assigning of the loyalty reward points being further based on a performance statistic associated with the fantasy amateur athletic team.

17. The computer readable medium of claim 15 wherein the method further comprises assigning further sponsorship loyalty reward points to the consumer based on a change in the performance statistic associated with the one of the amateur athletes.

18. The computer readable medium of claim 15 wherein the method further comprises providing a template to an amateur athletic league through which the amateur athletic league is granted access to participate in the method.

19. The computer readable medium of claim 18 wherein a sponsor of the amateur athletic league is granted access to participate in the method through the template.

20. The computer readable medium of claim 18 wherein an amateur athlete is granted access to participate in the method through the template.
